(19) United States
(12) Patent Application Publication
(10) Pub. No.: US 2022/0090442 A1
(43) Pub. Date: Mar. 24, 2022

(54) EXPANDABLE SHUTTER ASSEMBLY

(71) Applicant: William Gadsby, Killeen, TX (US)

(72) Inventor: William Gadsby, Killeen, TX (US)

(21) Appl. No.: 17/030,794

(22) Filed: Sep. 24, 2020

(51) Int. Cl. E06B 7/082

(52) U.S. Cl. CPC E06B 7/082

(57) ABSTRACT

An expandable shutter assembly for installing shutters in windows of varying widths includes a frame that has a first section slidably engaging a second section such that the frame has an adjustable length. A plurality of shutters is each pivotally coupled to the frame, and the shutters are positionable between an open position and a closed position. Each of the shutters comprises a first portion slidably engaging a second portion such that each of the shutters has an adjustable length to correspond to the length of the frame. A linkage is movably coupled to each of the shutters and the linkage urges each of the shutters between the open position and the closed position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shutter devices and more particularly pertains to a new shutter device for installing shutters in windows of varying widths.

### (2) Description of Related Art Including Information Disclosed Under 37 CFR 1.97 and 1.98

The prior art relates to shutter devices including a shutter assembly with transparent slats. The prior art discloses an adjustable shutter having an adjustable frame and a plurality of adjustable shutters, and each of the shutters has a concavely arcuate profile. The prior art discloses a shutter assembly that includes a plurality of rods that pivotally engage a frame. The prior art discloses a shutter device that includes an angled section of a frame for tilting the shutter device at an angle with respect to a window opening. The prior art discloses a shutter device that includes a plurality of wings being pivotally coupled to a frame.

### BRIEF SUMMARY OF THE INVENTION

An embodiment of the disclosure meets the needs presented above by generally comprising a frame that has a first section slidably engaging a second section such that the frame has an adjustable length. A plurality of shutters is each pivotally coupled to the frame, and the shutters are positionable between an open position and a closed position. Each of the shutters comprises a first portion slidably engaging a second portion such that each of the shutters has an adjustable length to correspond to the length of the frame. A linkage is movably coupled to each of the shutters and the linkage urges each of the shutters between the open position and the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an expandable shutter assembly according to an embodiment of the disclosure.

FIG. 2 is a back view of an embodiment of the disclosure.

FIG. 3 is a back phantom view of an embodiment of the disclosure.

FIG. 4 is a cross sectional view taken along line 4-4 of FIG. 3 of an embodiment of the disclosure showing shutters in a closed position.

FIG. 5 is a cross sectional view taken along line 4-4 of FIG. 3 of an embodiment of the disclosure showing shutters in an open position.

### DETAILED DESCRIPTION OF THE INVENTION

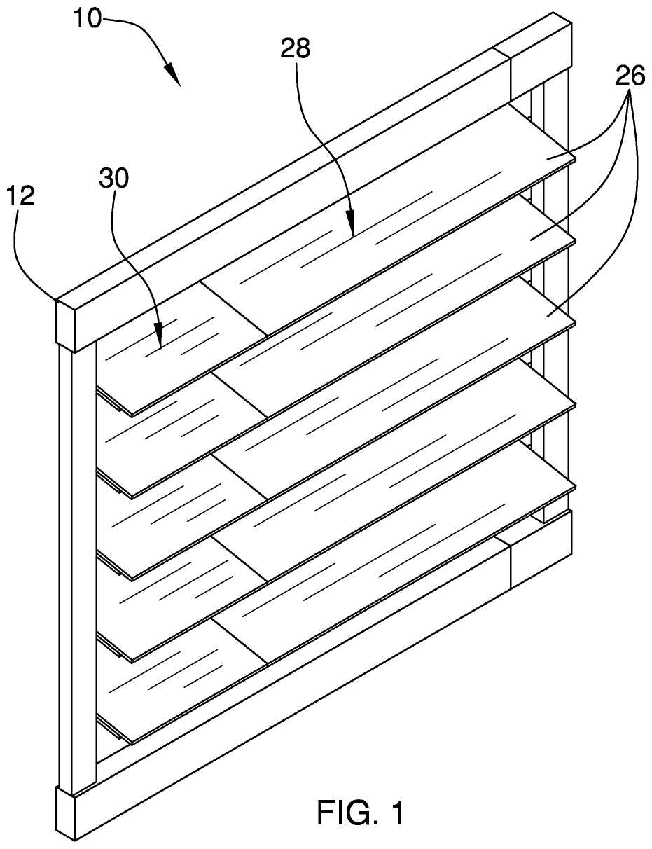

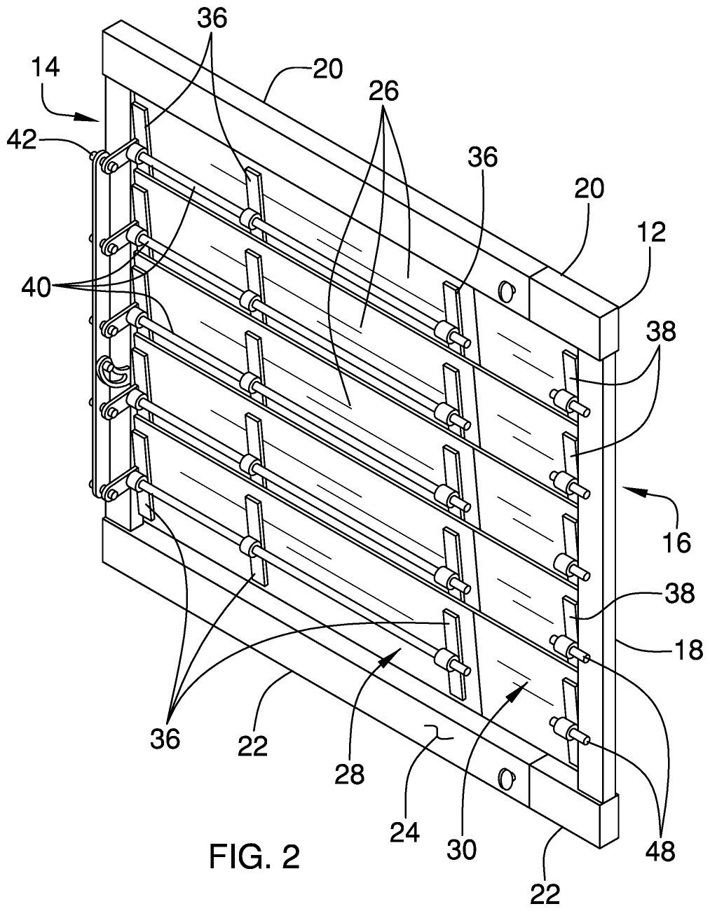

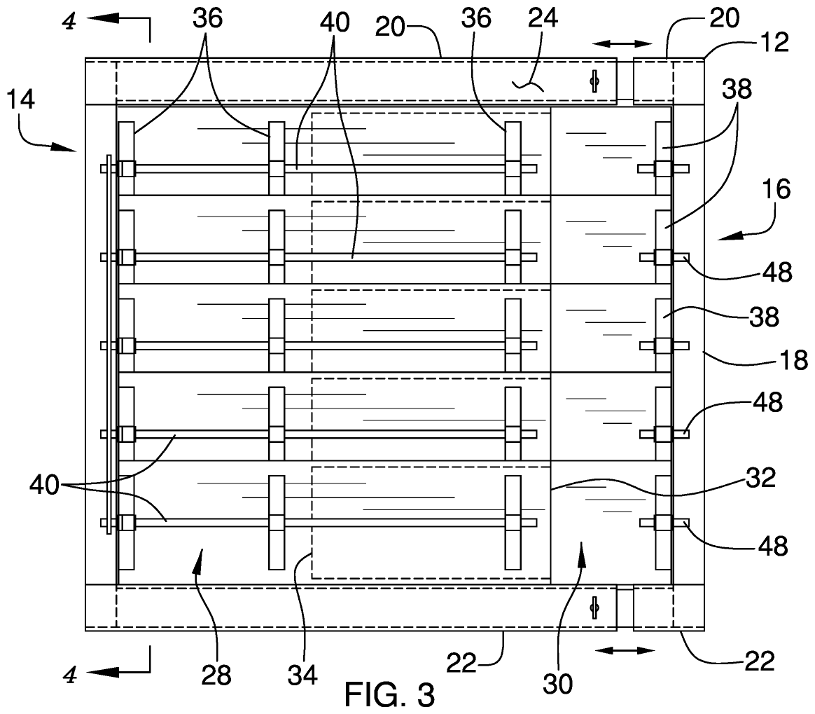

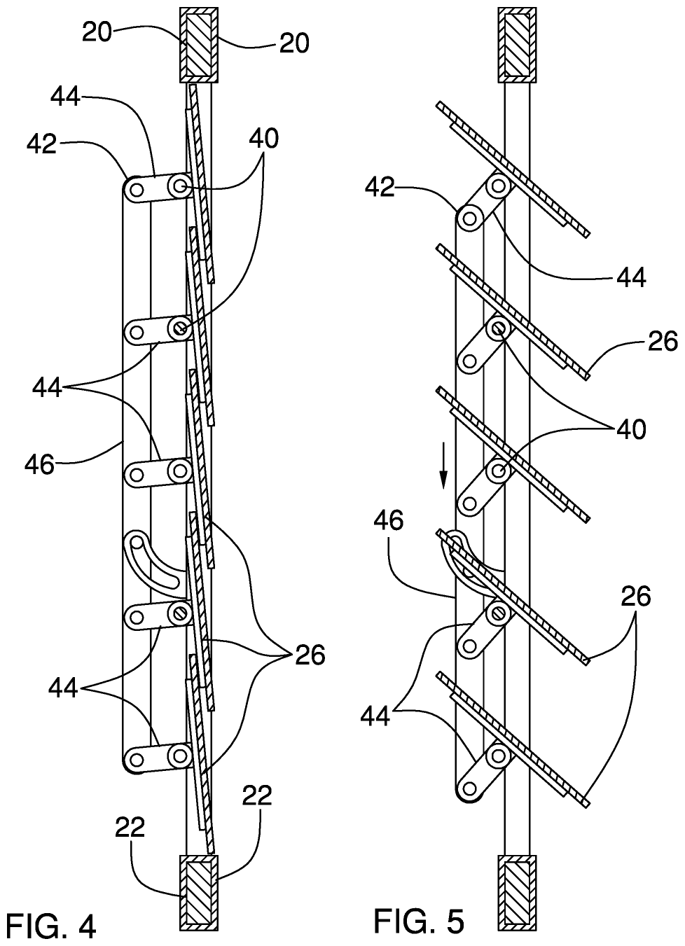

With reference now to the drawings, and in particular to FIGS. 1 through 5 thereof, a new shutter device embodying the principles and concepts of an embodiment of the disclosure and generally designated by the reference numeral 10 will be described.

As best illustrated in FIGS. 1 through 5, the expandable shutter assembly 10 generally comprises a frame 12 that has a first section 14 slidably engaging a second section 16 such that the frame 12 has an adjustable length. In this way the frame 12 can be positioned in window openings of various lengths. Each of the first section 14 and the second section 16 comprises a central member 18 extending between an upper member 20 and a lower member 22. Each of the upper member 20 and the lower member 22 of the first section 14 is hollow. Moreover, each of the upper member 20 and the lower member 22 of the first section 14 slidably receives a respective one of the upper member 20 and the lower member 22 of the second section 16. In this way the central member 18 of each of the first section 14 and the second section 16 is positionable an adjustable distance away from each other. The central member 18 of each of the first section 14 and the second section 16 has a rear surface 24.

A plurality of shutters 26 is provided and each of the shutters 26 is pivotally coupled to the frame 12. The shutters 26 are positionable between an open position and a closed position. Each of the shutters 26 comprises a first portion 28 slidably engaging a second portion 30 such that each of the shutters 26 has an adjustable length. In this way the shutters 26 can be adjusted to a length that corresponds to the length of the frame 12. The first portion 28 of each of the shutters 26 has a first end 32, the first portion 28 of each of the shutters 26 is hollow and the second portion 30 of each of the shutters 26 has a primary end 34. The first end 32 of the first portion 28 of the shutters 26 slidably receives the primary end 34 of the second portion 30 of the shutters 26.

A plurality of first receivers 36 is each coupled to the back surface of the first portion 28 of a respective one of the shutters 26. A plurality of second receivers 38 is each coupled to the back surface of the second portion 30 of a respective one of the shutters 26. A plurality of first rods 40 is provided and each of the first rods 40 engages each of the first receivers 36 on a respective one of the shutters 26. Each of the first rods 40 pivotally engages the central member 18 of the first section 14 of the frame 12.

A linkage 42 is movably coupled to each of the shutters 26 and the linkage 42 urges each of the shutters 26 between the open position and the closed position. The linkage 42 is coupled to each of the first rods 40, and the linkage 42 includes a plurality of first arms 44 each being pivotally coupled to a second arm 46. Each of the first arms 44 engages a respective one of the first rods 40 having the second arm 46 being vertically oriented. A plurality of second rods 48 each engages the second receiver 38 on a respective one of the shutters 26. Additionally, each of the second rods 48 pivotally engages the central member 18 of the second section 16 of the frame 12.

In use, the frame 12 is positioned in a window opening and the frame 12 is adjusted in width to extend across the entire width of the window opening. Additionally, each of the shutters 26 extends, or shortens, along with the frame 12 when the frame 12 is adjusted. In this way the frame 12 and the shutters 26 can be positioned in a variety of sizes of window openings. The linkage 42 is manipulated to position the shutters 26 between the open position and the closed position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An expandable shutter assembly for shuttering a variety of window opening sizes, said assembly comprising:
a frame having a first section slidably engaging a second section such that said frame has an adjustable length wherein said frame is configured to be positioned in window openings of various lengths;
a plurality of shutters, each of said shutters being pivotally coupled to said frame, said shutters being positionable between an open position and a closed position, each of said shutters comprising a first portion slidably engaging a second portion such that each of said shutters has an adjustable length to correspond to the length of said frame; and
a linkage being movably coupled to each of said shutters, said linkage urging each of said shutters between said open position and said closed position.

2. The assembly according to claim 1, wherein each of said first section and said second section comprises a central member extending between an upper member and a lower member, each of said upper member and said lower member of said first section being hollow, each of said upper member and said lower member of said first section slidably receiving a respective one of said upper member and said lower member of said second section, said central member of each of said first section and said second section being positionable an adjustable distance away from each other, said central member of each of said first section and said second section having a rear surface.

3. The assembly according to claim 1, wherein said first portion of each of said shutters has a first end, said first portion of each of said shutters being hollow, said second portion of each of said shutters having a primary end, said first end of said first portion of said shutters slidably receiving said primary end of said second portion of said shutters, each of said first portion and said second portion of each of said shutters having a back surface.

4. The assembly according to claim 3, further comprising a plurality of first receivers, each of said first receivers being coupled to said back surface of said first portion of a respective one of said shutters.

5. The assembly according to claim 4, wherein:
each of said first section and said second section comprises a central member extending between an upper member and a lower member; and
said assembly includes a plurality of first rods, each of said first rods engaging each of said first receivers on a respective one of said shutters, each of said first rods pivotally engaging said central member of said first section of said frame.

6. The assembly according to claim 3, further comprising:
a plurality of first receivers; and
a plurality of second receivers, each of said second receivers being coupled to said back surface of said second portion of a respective one of said shutters.

7. The assembly according to claim 6, further comprising:
a plurality of first rods; and
a plurality of second rods, each of said second rods engaging said second receiver on a respective one of said shutters, each of said second rods pivotally engaging said central member of said second section of said frame.

8. The assembly according to claim 5, wherein said linkage is coupled to each of said first rods, said linkage including a plurality of first arms each being pivotally coupled to a second arm, each of said first arms engaging a respective one of said first rods having said second arm being vertically oriented.

9. An expandable shutter assembly for shuttering a variety of window opening sizes, said assembly comprising:
a frame having a first section slidably engaging a second section such that said frame has an adjustable length wherein said frame is configured to be positioned in window openings of various lengths, each of said first section and said second section comprising a central member extending between an upper member and a lower member, each of said upper member and said lower member of said first section being hollow, each of said upper member and said lower member of said first section slidably receiving a respective one of said upper member and said lower member of said second section, said central member of each of said first section and said second section being positionable an adjustable distance away from each other, said central member of each of said first section and said second section having a rear surface;
a plurality of shutters, each of said shutters being pivotally coupled to said frame, said shutters being positionable between an open position and a closed position, each of said shutters comprising a first portion slidably engaging a second portion such that each of said shutters has an adjustable length to correspond to the length of said frame, said first portion of each of said shutters having a first end, said first portion of each of said shutters being hollow, said second portion of each of said shutters having a primary end, said first end of said first portion of said shutters slidably receiving said primary end of said second portion of said shutters, each of said first portion and said second portion of each of said shutters having a back surface;
a plurality of first receivers, each of said first receivers being coupled to said back surface of said first portion of a respective one of said shutters;
a plurality of second receivers, each of said second receivers being coupled to said back surface of said second portion of a respective one of said shutters;
a plurality of first rods, each of said first rods engaging each of said first receivers on a respective one of said shutters, each of said first rods pivotally engaging said central member of said first section of said frame;
a linkage being movably coupled to each of said shutters, said linkage urging each of said shutters between said open position and said closed position, said linkage being coupled to each of said first rods, said linkage including a plurality of first arms each being pivotally coupled to a second arm, each of said first arms engaging a respective one of said first rods having said second arm being vertically oriented; and
plurality of second rods, each of said second rods engaging said second receiver on a respective one of said shutters, each of said second rods pivotally engaging said central member of said second section of said frame.
